(19) United States
(12) Patent Application Publication
(10) Pub. No.: US 2006/0225055 A1
(43) Pub. Date: Oct. 5, 2006

(54) Method, system, and device for indexing and processing of expressions

(75) Inventor: Vincent Hsiang Tieu, Torrance, CA (US)

Correspondence Address: NIXON PEABODY, LLP, 401 9TH STREET, NW, SUITE 900, WASHINGTON, DC, 20004-2128, US

(73) Assignee: ContentGuard Holdings, Inc., Wilmington, DE (US)

(21) Appl. No.: 11/070,293

(22) Filed: Mar. 3, 2005

(51) Int. Cl. G06F 9/45

(52) U.S. Cl. 717/141; 717/143

(57) ABSTRACT

A method, system, and device for indexing expressions for use in a system for processing the expressions, and including indexing an expression using a semantic value; receiving a query; generating a list of prospective expressions from indexed expressions based on the query; and processing the prospective expressions.

### BACKGROUND OF THE INVENTION

1. Field of the Invention

The present invention generally relates to processing of grammar-based expressions, such as rights expressions, and the like, and more particularly to a method, system, and device for optimizing processing of expressions, including indexing of expressions, such as rights expressions, and the like.

2. Discussion of the Background

Declarative Meta languages have been promoted heavily in the information technology industry since the early 1990s by industry leaders such as Microsoft, IBM, and Sun Microsystems. Since that time, an increasing number of systems and applications have adopted the use of Meta languages. One such Meta language, XML, has become the de facto standard.

By themselves, Meta languages typically do not carry machine-interpretable semantics. However, there has been a great industry demand for machine-interpretable semantics to automate business transactions and facilitate interoperability across devices, platforms, and systems. Driven by this demand, enterprises and industry standard groups have developed rights expression grammars to overlay a Meta language. Such grammars capture the semantics of rights expressions. Analogous to the relationship between a clause and the grammar in a natural language, a rights expression can be a specific clause based on and compliant with the rights expression grammar.

Exemplary rights expression grammars can include eXtensible rights Markup Language (XrML), MPEG Rights Expression Language (REL) (MPEG REL), Open Digital Rights Language (ODRL), Open Mobile Alliance (OMA) REL (OMA REL), Content Reference Forum Contract Expression Language (CRF CEL), OASIS eXtensible Access Control Markup Language (XACML), OASIS Security Assertion Markup Language (SAML), and the like. Exemplary rights expressions can include XrML licenses that govern the use of Microsoft RMS-enabled Office documents, XML licenses that govern the use of Digital Rights Management (DRM) enabled Windows Media content, SAML assertions in Web Services applications, CEL-based electronic contracts (eContracts) for CRF-targeted business scenarios, and the like.

Rights expressions can be used in a wide variety of systems and applications, including agreements between business entities, permissions granted by rights holders to distributors and consumers, policies and rules governing computer system behaviors, digital identification, digital certificate, a token that asserts an entity's identity and attributes, a token that asserts an entity's privileges in a government or enterprise security environment, and the like. Exemplary objectives of rights expressions include facilitating human-to-machine and machine-to-machine communications, enabling precise and unambiguous machine interpretation, and the like. However, the syntax and semantics of rights expression grammars are not always designed for optimal real-time processing efficiency, as transformation of an original rights expression format into a machine-internal representation often may be required.

In addition, digital signatures often are imposed on rights expressions to authenticate the integrity of the rights expressions. For privacy protection, rights expressions may be further protected by cryptographic means, such as by encryption techniques, and the like. To mitigate size, bandwidth, or other constraints, rights expression may be encoded in different formats. For example, a rights expression may be encoded in a binary format to reduce the size of the rights expression in a mobile communication environment. However, transformations, digital signatures, security protection, encoding, and other potential formatting can introduce undesirable overhead with respect to the processing of rights expressions.

As grammar-based rights expressions become the prevalent means for communicating and enforcing rights terms on machine-interpreted and/or enforced transactions, many systems and applications may need to process large volumes of rights expressions efficiently. For example, a consumer's personal computer may contain thousands of licenses, each of which governs the use of one specific digital work or a group of digital works. In another example, a rights clearing center may manage and process millions of electronic licenses and contracts in response to frequent queries. In a further example, a large retailer may implement an automated contract issuance and management system that stores contractual agreements (e.g., expressed in a contract expression language) between the retailer and hundreds or thousands of suppliers. However, such an application would undesirably require a gigantic database of digital contracts.

In addition, a rights expression management system may need to satisfy a fixed response-time requirement. For example, the rights expression management system may need to deliver rights expressions in the form of authorization tokens, and the like, for viewing of streaming video on consumption devices in fixed interval, such as every second, and the like. However, such an application could be undesirably hindered when trying to process large volumes of rights expressions.

Further, in a rights expression processing system, rights expressions may be stored sequentially in a persistent repository and captured in an original Meta language syntax. The rights expressions may be binary encoded, digitally signed, security protected, formatted by other means, and the like. Triggered by a processing request, the rights expression processing system would process the rights expressions in a linear fashion, typically including the following steps.

A processing step can include selecting rights expressions relevant to a processing request. The processing request typically encompasses specific context. For example, a request might impose the query, “does music distributor X have the permission from record company Y to sell its content in territory Z”. In this case, “X”, “Y”, “Z”, and “sell” can be used as filters to select the relevant rights expressions. In other words, such a processing request is interested in the rights expressions that satisfy the noted filtering criteria. Depending on the type of processing request, the system may need to find the first rights expression that matches the query, a subset of rights expressions that match the query or all rights expressions that match the query.

A processing step can include validating rights expressions, wherein set of matching rights expressions from the selecting step are validated and verified. The validating step can include reversing a binary encoding process, decrypting, verifying a digital signature to confirm integrity, validating the syntax of rights expressions against a grammar, and the like.

A processing step can include interpreting rights expressions, including extracting the semantic meaning from rights expressions to construct information used for a response to a processing request. The interpreting also step may involve retrieving and processing other related rights expressions, if any, needed for the response. For example, a usage right may only be granted if the principal possesses another (pre-requisite) right. In this case, the system must search for and verify that the principal does possess the required pre-requisite right before granting the usage right.

A processing step can include responding to a processing request. For example, after the above processing steps have been completed, the responding step can include determining if conditions, obligations, and the like, associated with rights expressions have been satisfied in order to respond to the processing request.

However, the above-noted processing steps can be computing resource and processing intensive, especially when dealing with rights expressions that are complicated, lengthy, dependant on other rights expressions, and the like. Accordingly, without a systematic method to organize and manage high volumes of rights expressions, it can be very difficult, and in some instances impossible, to respond to query, event, authorization, other processing requests, and the like, in a timely manner. Thus, methods and systems for processing rights expressions typically are not practical or efficient, when managing thousands or even millions of rights expressions.

### SUMMARY OF THE INVENTION

Therefore, there is a need for a method, system, and device that addresses the above and other problems with Digital Rights Management (DRM) systems, and methods. The above and other needs are addressed by the exemplary embodiments of the present invention, which provide a method, system, and device for processing of expressions, including rights expressions. The exemplary embodiments include indexing of expressions, including rights expressions, so that, when given a processing request, expressions with no potential of satisfying the processing request are eliminated from the search space before the expression processing begins. During the processing of a request and subsequent chaining requests (e.g., additional requests resulting from dependencies among expressions), the expression processor processes only expressions with the potential of satisfying the processing request. Advantageously, such processing greatly reduces the number of relevant expressions that need to be processed in association with the processing request and, among other things, leads to reduced response time. The indexing can be based on semantic and/or syntactic values of the expressions being processed. The process of analyzing and organizing expressions so that prospective expressions can be quickly queried and retrieved later is part of an exemplary expression index maintenance process that can be performed independently of a real-time request evaluation process (e.g., during an expression storage sub-process, through a batch process, and the like). Advantageously, the overhead processing time for the exemplary expression index maintenance process can be excluded from the processing time of evaluating a request. In addition, the exemplary embodiments can be used to process numerous types of expressions, including rights expressions, and the like.

Accordingly, in exemplary aspects of the present invention, a method, system, and device for indexing expressions for use in a system for processing the expressions are provided, and including indexing an expression using a semantic value; receiving a query; generating a list of prospective expressions from indexed expressions based on the query; and processing the prospective expressions.

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 illustrates an exemplary data flow for processing of an expression request in an exemplary system for processing expressions;

FIG. 2 illustrates an exemplary Expression Index Engine of the system of FIG. 1;

FIG. 3 illustrates an exemplary control flow for indexing of expressions in the system of FIG. 1;

FIG. 4 illustrates an exemplary control flow for querying of indexed expressions in the system of FIG. 1; and

FIG. 5 illustrates a further exemplary system for processing of expressions and which can be used with the exemplary embodiments of FIGS. 1-4.

### DETAILED DESCRIPTION OF THE PREFERRED EMBODIMENTS

An improved method, system, and device for optimizing processing of expressions, including indexing of expressions, such as rights expressions, and the like, are described. In the following description, for purposes of explanation, numerous specific details are set forth in order to provide a thorough understanding of the exemplary embodiments of the present invention. It is apparent to one skilled in the art, however, that the present invention can be practiced without these specific details or with an equivalent arrangement. In some instances, well-known structures and devices are shown in block diagram form in order to avoid unnecessarily obscuring the present invention.

The exemplary embodiments generally include indexing of expressions, for example, based on semantic and/or syntactic values of the expressions. The exemplary embodiments can include an Expression Index Engine that indexes expressions, including rights expressions, and generates a list of prospective expressions based on a query.

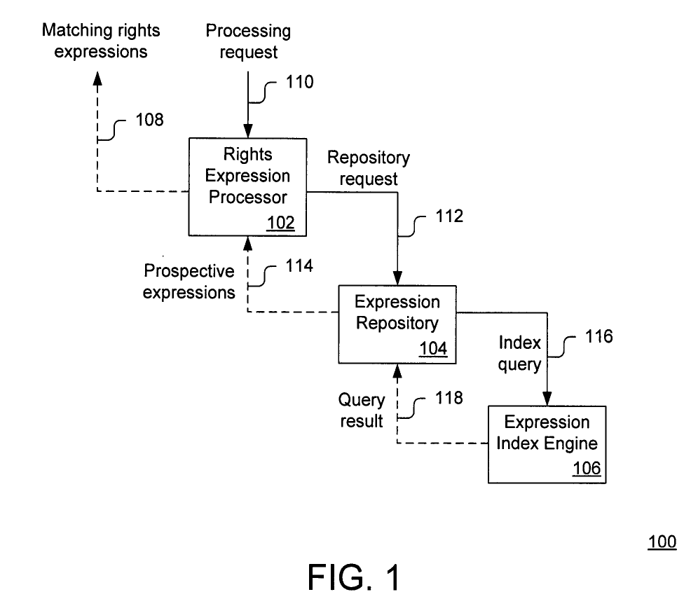

Referring now to the drawings, wherein like reference numerals designate identical or corresponding parts throughout the several views, and more particularly to FIG. 1 thereof, there is illustrated an exemplary data flow for processing of an expression request in an exemplary system 100 for processing expressions. In FIG. 1, the processing of an expression processing request 110 can include employing an Expression Index Engine 106 that can be used by a Rights Expression Processor 102. However, any suitable processor for processing of any suitable type of expression can be employed with the Expression Index Engine 106, according to further exemplary embodiments.

Accordingly, the Rights Expression Processor 102 receives the processing request 110. The Rights Expression Processor 102 processes the processing request 110 by selecting expressions relevant to the processing request 110, validating the expressions, evaluating the expressions, and responding to the processing request 110. To retrieve the expressions relevant to the processing request 110, the Rights Expression Processor 102 issues a repository request 112 to an Expression Repository 104.

The Expression Repository 104 stores and retrieves expressions. Upon receiving the repository request 112, the Expression Repository 104 converts the repository request 112 to an index query 116 for use in invoking the Expression Index Engine 106.

The Expression Index Engine 106 analyzes an indexed collection of expressions and retrieves a set of expressions that satisfy the index query 116. The set of expressions is returned to the Expression Repository 104 as a query result 118. The Expression Repository 104 returns the query result 118 to the Rights Expression Processor 102 as a set of prospective expressions 114 with the potential to satisfy the processing request 110. The Rights Expression Processor 102 then performs additional processing on the prospective expressions 114 to identify matching expressions 108 that satisfy the processing request 110.

Advantageously, the Expression Index Engine 106 and components thereof can be used in connection with any suitable form of expression. In an exemplary embodiment, the Expression Index Engine 106 is used in connection with rights expressions, and in which case can be referred to as a Rights Expression Index Engine. The other exemplary components are similarly described using interchangeable language, such as the Expression Repository 104 and Rights Expression Repository, Expression Processor and the Rights Expression Processor 102, and the like.

The exemplary embodiments describe an abstract model by defining concepts, terminologies, methods, and the like, associated with indexing expressions, including rights expressions, and querying indexed expressions. Such an abstract model serves as a reference on which various exemplary systems for indexing rights expressions, querying indexed rights expressions, and the like, for a variety of rights expression languages can be implemented.

In an exemplary embodiment, an evaluation unit can be an expression element that represents some logical grouping of other expression elements. One example of an evaluation unit in the domain of rights expressions is an authorization unit. An authorization unit is a rights expression element that represents a logical grouping of rights expression elements that allows some identity or entity to exercise some right or action on some resource. For example, in the MPEG REL, an authorization unit can be expressed using a grant element. Similarly, in ODRL, for example, an authorization unit can be expressed using an agreement element. Other grammar based rights expression languages also have similar logical representation. Each rights expression element can have a type associated with therewith. Each rights expression element also can represent some semantic meanings that are specific to the rights expression language in which the rights expression is expressed.

In an exemplary embodiment, a dimensional element can be an expression element of an evaluation unit that is being used to compute an indexed value. The evaluation unit can be independently indexed by one or more dimensional elements based on values and types of the dimensional elements. The selection of dimensional elements can be based on the anticipated processing request 110, such that dimensional elements have corresponding input parameters with the processing request 110. When the indexed values of the dimensional elements within an evaluation unit match the indexed values of the input parameters of the processing request 110, the evaluation unit has the potential to satisfy the processing request 110.

In its simplest form, an evaluation unit can include a single dimensional element. In this case, the dimensional element is the evaluation unit and vice versa.

The exemplary embodiments include an exemplary expression indexing method defined in terms of an authorization unit as an example. However, the exemplary expression indexing method can be applied more generally to any suitable evaluation unit, and the term authorization unit and evaluation unit can be used interchangeably.

Many rights expression languages have their own optimized methods for representing the information stored in the expressions. For example, as in the MPEG REL, grants with the same principal can be grouped together into a grant group so that the principal need not be declared repeatedly in each grant. Similarly, as in ODRL, agreement expressions can inherit permissions and constraints from another expression. Such optimization reduces the number of expressions employed to represent the required statements.

Before an authorization unit can be indexed, the authorization unit can be processed so as to be self-contained. In an exemplary embodiment, such processing can include determining expressions that are semantically associated with the authorization unit, but are syntactically defined outside of the authorization unit, and then distributing the determined expressions into the authorization unit so that the authorization unit is made to be self-contained. A general mechanism for such processing is further described in U.S. patent application Ser. No. ______ (Attorney Docket No. 111325-510100) of Thanh T A, et al., filed on Aug. 17, 2004, entitled “METHOD AND SYSTEM FOR PROCESSING GRAMMAR-BASED LEGALITY EXPRESSIONS,” and incorporated by reference herein.

In an exemplary embodiment, a rights expression element can be specified, for example, as a static expression, which has an actual, static value explicitly specified within the element or as a variable expression, which references a variable definition with zero or more constraints. A static value that satisfies the constraints can be bound to the variable expression.

In an exemplary embodiment, a primary index key value of a dimensional element can include a hash value computed from the type and value of the dimensional element or a hash value computed from the type of the dimensional element and a unique value assigned to the dimensional element, and the like. Authorization units including a particular dimensional element with the same primary index key value can be collected into the same collection indexed by such primary index key value. The use of the assigned unique value can be employed when the actual value of the dimensional element cannot be determined at the time of indexing, such as when the value for a variable expression can not be assessed. Such assigned unique value can be termed a unique potential match value. Exemplarily methods of determining the primary index key value of a dimensional element and arranging authorization units into collections are described below.

For example, for each dimensional element, authorization units that include variable expressions for the corresponding dimensional element can be collected into one potential match collection indexed by the hash value computed from the type value of the dimensional element and the unique potential match value. Since a variable expression serves as a place holder for some static values and the binding of a static value to a variable expression is not determined until the interpretation process, the unique potential match value can be used.

Furthermore, a rights expression language can define the presence of an expression element to be optional. Consequently, a dimensional element within an authorization unit can be left unspecified. For each dimensional element, authorization units that do not have the corresponding dimensional element also are collected into the potential match collection indexed by the hash value computed from the type value of the dimensional element and the unique potential match value. In this case, the unique potential match value is used because a static value can not be determined for an unspecified dimensional element and the semantic of an unspecified element is not clearly defined at the time of indexing. An unspecified element may have the semantic of allowing any suitable expression element to match, allowing no expression element to match or defining an error if the expression element is actually required, but not specified by mistake. Authorization units belonging to the potential match collection qualify as potential matches to an index query.

Several expression elements may appear syntactically different, but may represent the same semantic meaning. For example, a person being identified by social security number 123-45-6789 can be syntactically expressed differently using the following expressions:

### Exemplary Expression 1

<person>

<name>Bob</name>
<ssn>123-45-6789</ssn>
<licenseNumber>C7654321</licenseNumber>

</person>

### Exemplary Expression 2

<person>

<ssn>123-45-6789</ssn>
<name>Bob</name>

</person>

### Exemplary Expression 3

<person>

<ssn>123-45-6789</ssn>
<licenseNumber>C7654321</licenseNumber>

</person>

In this example, the grammatical structure for the person element requires only that the ssn element be present. The name and licenseNumber elements are optional elements, and there is no fixed ordering among such elements. Accordingly, an optional element can include an expression element that is not required to be specified explicitly according to the grammatical structure of an expression language.

The syntactic value of an expression element can be based strictly on the static string value (commonly referred to as the static value) of the expression element. For example, the syntactic value for the exemplary Expression 1 can be the following string:

“<person>

<name>Bob</name>
<ssn>123-45-6789</ssn>
<licenseNumber>C7654321</licenseNumber>

</person>”

When indexing a dimensional element based on a syntactic value of the dimensional element, the hash value computed from a static value of the dimensional element and the element type of the dimensional element represent a primary index key value of the dimensional element. For each dimensional element, authorization units that include the dimensional element with the same static value are collected into the same set indexed by the type and value of the dimensional element.

The semantic value of an expression element can be a static value determined by applying some transformation rules so that related expression elements having different syntactic values, but representing the same semantic meaning, have the same static value. The determined static value based on semantic meaning is called the seed syntactic value.

The criteria for determining a seed syntactic value depend on the context of an element. One way to determine the seed syntactic value is to remove optional elements and attributes. Also, when an instance of a dimensional element includes multiple children elements and the position of the children elements is not semantically significant and can vary, the children elements can be rearranged into a default, fixed position, before calculating the seed syntactic value. Alternatively, an exemplary system can include a semantic-specific plug-in architecture, where each plug-in has specific knowledge of the semantic context of an element to determine the appropriate seed syntactic value. Such alternatives are just some of many possible exemplary embodiments of methods that can be used to determine the seed syntactic value when indexing a dimensional element based on the semantic value of the dimensional element.

Using the exemplary embodiments to represent a person being identified by the social security number 123-45-6789 by removing optional elements to determine the seed syntactic value yields the following seed syntactic value for which a primary index key value can be computed.

“<person>

<ssn>123-45-6789</ssn>

</person>”

When indexing a dimensional element based on a semantic value of the dimensional element, authorization units that include the same dimensional element type with the same semantic value, but possibly different syntactic values, can be collected into the same collection indexed by the hash value computed from the type value of the dimensional element and a seed syntactic value as the primary index key value.

For an index query 116 relating to an authorization request, the expected query result 118 is a collection of prospective authorization units that have potential to match the authorization request. Such collection of prospective authorization units can be determined by the intersection of collections of authorization units for all dimensional elements denoted as ∩(M(d₁), M(d₂), . . . M(dₙ)). However, the intersection operation can be substituted with other suitable mathematical operations as applicable to the processing request, such as union of collections of authorization units for all dimensional elements, collections of authorization units with at least N number of matching dimensional elements, collections of authorization units that statistically exceed a certain percentage of inclusion in previous query results, collections of authorization units that statistically exceeds a certain percentage of uses, other suitable operations or combinations thereof, and the like. For each dimensional element Dᵢ, M(dᵢ) is the collection of all authorization units that include rights expression elements corresponding to the dimensional element type of Dᵢ, with element values that semantically and syntactically match or potentially match the type and value of dᵢ, where dᵢ is an input element from the processing request 110 that corresponds to the dimensional element Dᵢ.

Authorization units that include rights expression elements corresponding to the dimensional element Dᵢ whose indexed value matches the indexed value computed from the element type and value of dᵢ, are considered matches with dᵢ and are placed into the M(dᵢ) collection. In addition, authorization units that include rights expression elements corresponding to the dimensional element Dᵢ whose indexed value matches the indexed value computed from the element type of dᵢ and the unique potential match value, are considered potential matches with dᵢ and also are placed into the M(dᵢ) collection. In effect, for each dimensional element Dᵢ, such exemplary steps eliminate authorization units that do not match the input element dᵢ. The next step involves determining the intersected collection by extracting only those authorization units that are present in all of the M(d₁), M(d₂), . . . M(dₙ) collections. This further eliminates authorization units that do not match the input elements d₁, d₂ . . . dₙ.

To ensure that the index collections are up to date, the collections need to be re-indexed when a rights expression is modified, added to or removed from a rights expression repository. For example, when an authorization unit is removed from the rights expression repository, the primary index key value for each dimensional element within the affected authorization unit is recalculated. The collections including the authorization unit are retrieved using the calculated primary index key value for each dimensional element. Then, the authorization unit is removed from the collections. When an authorization unit is modified, the original authorization unit is removed from the collection. Then, the modified authorization unit is added back to the collection using the previously defined process. In general, updating and removing authorization units need to maintain referential integrity between the primary index key value and the collections including the authorization units.

The process of analyzing and organizing expressions, and ensuring that the index collections are up to date so that prospective expressions can be quickly queried and retrieved later is called an expression index maintenance process. Since an expression index maintenance process is typically performed independently (e.g., at different times) from the request authorization process, the processing time for expression index maintenance can be excluded from the authorization processing time. Not having to perform expression index maintenance as a part of an authorization process, advantageously, can reduce the time and resources required for the authorization process. Authorization process efficiency is desirable, since authorization is typically a real-time process.

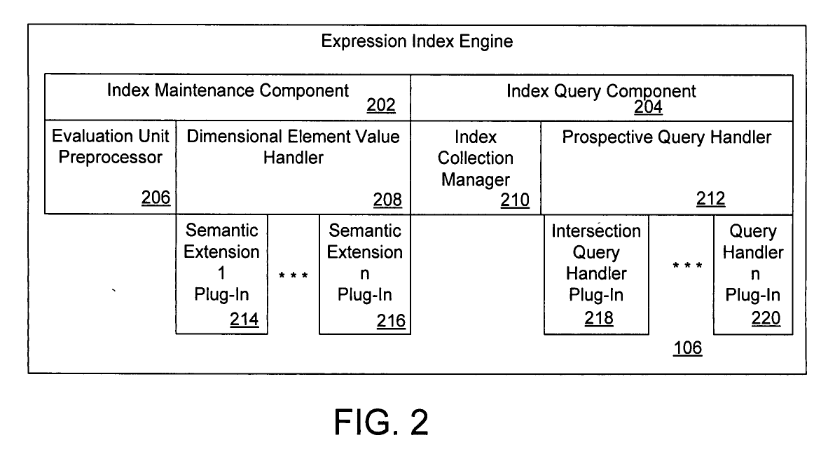

The exemplary embodiments include the components of the Expression Index Engine 106 and the interactions of the components with each other and with input data. FIG. 2 illustrates an exemplary Expression Index Engine 106 of the system of FIG. 1 and that can be used to process expressions, including rights expressions, and the like. Accordingly, the Expression Index Engine 106 can be used to provide functionalities for indexing rights expressions, advantageously, facilitating efficient retrieval of prospective authorization units.

In FIG. 2, the Expression Index Engine 106 can include an Index Maintenance Component 202 for adding, modifying, removing, and the like, rights expressions from an index collection. An Index Query Component 204 can be used for querying and retrieving prospective authorization units that have the potential to match the authorization request query. An Evaluation Unit Preprocessor 206 enables each authorization unit to be self-contained by factoring or including rights expressions defined outside of the authorization unit into the authorization unit itself. Such rights expressions are semantically associated with the authorization unit, but are defined externally for syntactical convenience. For example, the MPEG REL defines a convenience mechanism, whereby a LicensePartId is used to identify and define an expression element, which can be referenced later using the abbreviated syntax of a LicensePartIdRef.

A Dimensional Element Value Handler 208 can determine the syntactic or semantic value of a dimensional element. If the Expression Index Engine 106 is implemented to index authorization units based on syntactic value, the value of the dimensional element is the static value of the rights expression. If the Expression Index Engine 106 is configured to index authorization units based on semantic value, the Dimensional Element Value Handler 208 calculates the seed syntactic value of the dimensional element and uses the seed syntactic value as the value of the dimensional element.

Semantic Extension Plug-Ins 214-216 are associated with a particular dimensional element type and have specific knowledge of how to compute the seed syntactic value appropriately, such as according to the grammar. The Dimensional Element Value Handler 208 can delegate the task of calculating the seed syntactic value to one of the Semantic Extension Plug-Ins 214-126. The Dimensional Element Value Handler 208 can have one or more registered Semantic Extension Plug-Ins 214-216. Once a Semantic Extension Plug-Ins has calculated the seed syntactic value, the Dimensional Element Value Handler 208 can compute a hash value based on the type information and the seed syntactic value of the dimensional element. The hash value is the primary index key value used in indexing collection of authorization units.

An Index Collection Manager 210 manages the indexed collections of authorization units by providing updating the collection using the hash value as the primary index key value. The indexed collections can include repository references to the authorization units, rather than the actual authorization units themselves. The Index Collection Manager 210 also provides query functionality to retrieve a collection of authorization units given the hash value as the primary index key value.

A Prospective Query Handler 212 retrieves the collection of authorization units that potentially match with the processing request. The Prospective Query Handler 212 can have one or more registered Query Handler Plug-Ins 218-220 to specifically determine the collection of potential matched evaluation units as applicable to the processing request. For example, the Intersection Query Handler Plug-In 218 retrieves the collection of authorization units associated with each dimensional element that is part of an authorization request, and then determines the collection of authorization units that represents the intersection of the retrieved collections. Further exemplary embodiments, can include zero or more of the described components, depending on a given implementation.

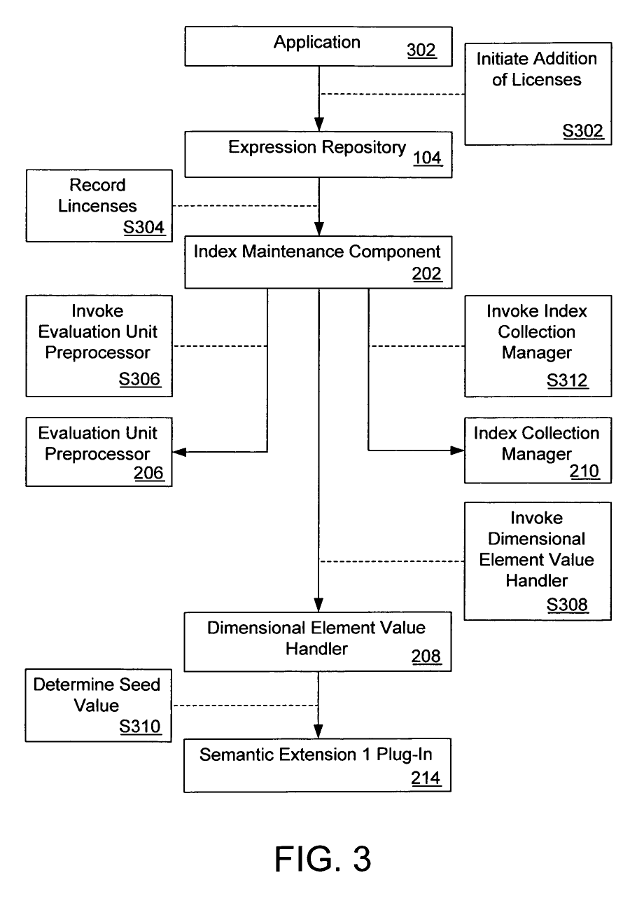

FIG. 3 illustrates an exemplary control flow for indexing of expressions in the system of FIG. 1, wherein rights expressions are added and indexed. In this scenario. At step S302, an application 320 initiates the “addition of licenses” command to the Rights Expression Repository 104. In this example, a license represents an authorization unit expressed in some form of rights expression.

At step S304, the Rights Expression Repository 104 records the licenses in a storage mechanism and invokes the Index Maintenance Component 202 to add rights expressions to the index collection. At step S306, the Index Maintenance Component 202 invokes the Evaluation Unit Preprocessor 206 for each authorization unit to ensure that the authorization unit is self-contained.

At step S308, the Index Maintenance Component 202 invokes the Dimensional Element Value Handler 208 for each dimensional element within the self-contained authorization unit to determine the hash value computed from the type information and value of the dimensional element. At step S310, the Dimensional Element Value Handler 208 can employ a Semantic Extension Plug-In 214 to determine the seed syntactic value of the dimensional element.

At step S312, the Index Maintenance Component 202 uses the hash value as primary index key value and invokes the Index Collection Manager 210 to add a reference to the authorization unit to the indexed collection. Further exemplary embodiments, can include zero or more of the described steps, depending on a given implementation.

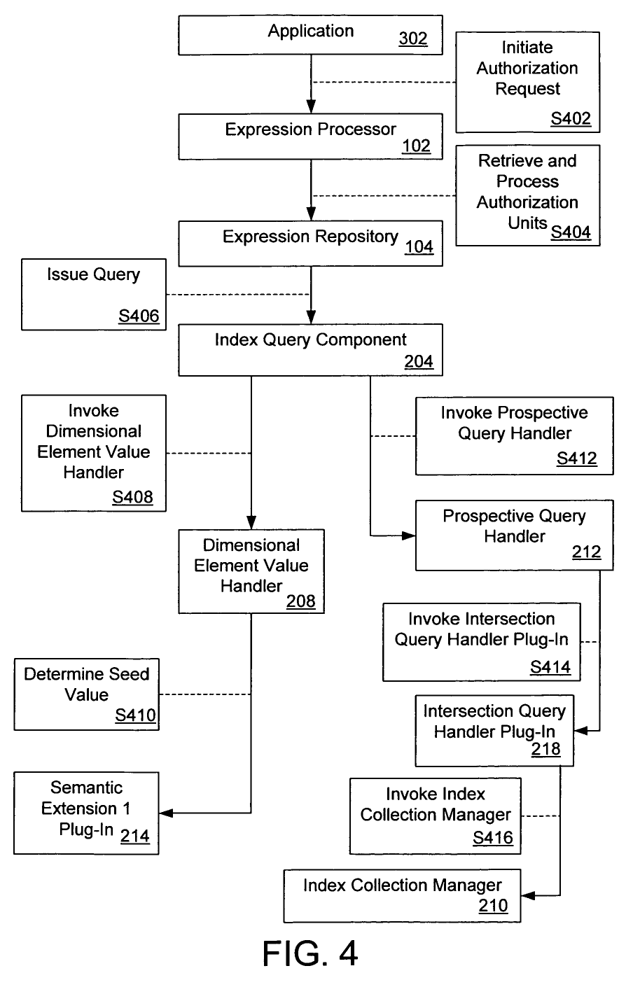

FIG. 4 illustrates an exemplary control flow for querying of indexed expressions in the system of FIG. 1, when rights expressions are being queried for prospective authorization units. At step S402, the application 320 initiates an authorization request to the Expression Processor 102 configured as an REL Interpreter. At step S404, the REL Interpreter issues a command to retrieve authorization units to process against the inputs from the authorization request.

At step S406, the Rights Expression Repository 104 issues a query to retrieve prospective authorization units. To form the query, the Rights Expression Repository 104 uses the input parameters from the authorization request that correspond to the dimensional elements of the authorization unit. At step S408, the Index Query Component 204 invokes the Dimensional Element Value Handler 208 for each dimension element in the query to determine the hash value computed from type information and value of the dimensional element.

At step S410, the Dimensional Element Value Handler 208 can employ a Semantic Extension Plug-In 214 to determine the seed syntactic value of the dimensional element. At step S412, the Index Query Component 204 invokes the Prospective Query Handler 212 to determine the collection of authorization units that potentially match with the processing request. At step S414, the Prospective Query Handler 212 can employ an Intersection Query Handler Plug-In 218 to retrieve the intersected collection based on the hash values.

At step S416, the Intersection Query Handler Plug-In 212 invokes the Index Collection Manager 210 for each hash value computed from the dimensional element to retrieve the collection of authorization units with the hash value as the primary index key value. Then, the Intersection Query Handler Plug-In 212 can determine the intersected collection by extracting authorization units that are present in all of the collections of authorization units retrieved from the Index Collection Manager 210. Further exemplary embodiments, can include zero or more of the described steps, depending on a given implementation.

The exemplary embodiments are applicable to expressions conveyed in any suitable manner, including any suitable rights expression language. For example, the rights expressions can be expressed in the MPEG REL. In the MPEG REL, an authorization unit is represented as a grant element. Within a grant element, the indexing is based on the semantic value of dimensional elements D₁=Principal, D₂=Rights, and D₃=Resource.

As an illustration of the exemplary indexing process, given the pseudo MPEG REL licenses in Table 1, the Expression Index Engine 106 indexes the rights expressions based on their semantic values, such that the primary index key values and their associated collections of grants are as shown in Table 2.

TABLE 1
Exemplary licenses.

| | | | |
|---|---|---|---|
| [L1] | license | [L2] | license |

| | | | |
|---|---|---|---|
| [Gg1] | grantGroup | [G1] | grant |

| | | |
|---|---|---|
| [G1] | grant | forAll varDef=”Cd1_Res” |

| | |
|---|---|
| keyHolder | anXmlExpression Pattern matches Let's Rock CD |

| | |
|---|---|
| info | keyHolder |

| | |
|---|---|
| KeyName “John” | info |

| | |
|---|---|
| RSAKeyValue | KeyName “Jane” |

| | |
|---|---|
| Modulus “Fadsl” | RSAKeyValue |

| | |
|---|---|
| Exponent “AQAB” | Modulus “Fjlkd” |

| | |
|---|---|
| Copy | Exponent “AQAB” |

| | |
|---|---|
| digitalResource “Let's Rock CD” | Copy |
| prerequisiteRight | Resource varRef= “Cd1_Res ” |

keyHolder

info

KeyName “John”
RSAKeyValue

Modulus “Fadsl”
Exponent “AQAB”

Own

digitalResource “Let's Rock CD”

| | |
|---|---|
| [G2] | grant |

keyHolder

info

RSAKeyValue

Modulus “Fadsl”
Exponent “AQAB”

KeyName “John”

Play
digitalResource “Let's Rock CD”

| | | | |
|---|---|---|---|
| [L3] | license | [L4] | license |

| | | | |
|---|---|---|---|
| [G1] | grant | [G1] | grant |

| | |
|---|---|
| forAll varDef=”Cd_Owners” | forAll varDef = “Cd_Buyers” |

| | |
|---|---|
| Pattern matches John | anXmlExpression Pattern matches Jack |

| | |
|---|---|
| Principal varRef=”Cd_Owners” | forAll varDef=”Own_Right” |

| | |
|---|---|
| Own | anXmlExpression Pattern matches Own right |

| | |
|---|---|
| digitalResource “Let's Rock CD” | forAll varDef=” Cd2_Res” |

anXmlExpression Pattern matches Cd2

Principal varRef=Cd_Buyers
Rights varRef = Own_Right
Resource varRef = “Cd2_Res”

To uniquely identify an authorization unit, Table 1 uses a convention of concatenating the labels that lead to the authorization unit or grant. For example, L1.Gg1.G2 represents the second grant of first grantGroup within the first license, which is the grant that allows John to play “Let's Rock CD.” In Table 2, each row represents an instance of a dimensional element being indexed and the corresponding authorization units. For example, in the first row of Table 2 both L1.Gg1.G1 and L1.Gg1.G2 include the Principal element type with keyHolder John. For brevity, the short form “keyHolder John” is used instead of the entire keyHolder element related to John. Note that even though the syntactic value of keyHolder John in L1.Gg1.G1 is different from L1.Gg1.G2 due to the different ordering of the KeyName and RSAKeyValue elements, their semantic values are the same.

TABLE 2
Indexed of rights expressions based on
semantic value of dimensional element.

| Dimensional Element | |
|---|---|
| Type(Dimensional Element Value) | Collection |
| Principal(keyHolder John) | L1.Gg1.G1, L1.Gg1.G2 |
| Principal(keyHolder Jane) | L2.G1 |
| Principal((_UniquePotentialMatchValue) | L3.G1, L4.G1 |
| Right(IssueCopy) | L1.Gg1.G1, L2.G1 |
| Right(Own) | L3.G1 |
| Right(Play) | L1.Gg1.G2 |
| Right((_UniquePotentialMatchValue) | L4.G1 |
| Resource(Let's Rock CD) | L1.Gg1.G1, |
| | L3.G1, L1.Gg1.G2 |
| Resource((_UniquePotentialMatchValue) | L2.G1, L4.G1 |

For an index query, the Expression Index Engine 106 retrieves the intersection of grants for Principal=D₁, Rights=D₂, and Resource=D₃, denoted as ∩(M(d₁), M(d₂), M(d₃)). For example, given an interpretation request “can John Copy Let's Rock CD” and the index table depicted in Table 2, d₁ equals a static value of the principal dimensional element D₁, d₂ equals a static value of the rights dimensional element D₂, and d₃ equals a static value of the resource dimensional element D₃. The Expression Index Engine 106 retrieves the ∩(M(d₁=John), M(d₂=Copy), M(d₃=Let's Rock CD)), as follows:

M(d₁=John)=L1.Gg1.G1, L1.Gg1.G2, L3.G1, L4.G1

M(d₂=Copy)=L1.Gg1.G1, L2.G1, L4.G1

M(d₃=Let's Rock CD)=L1.Gg1.G1, L1.Gg1.G2, L3.G1, L2.G1, L4.G1
∩(M(d₁=John), M(d₂=Copy), M(d₃=Let's Rock CD))=L1.Gg1.G1, L4.G1

Consequently, the Rights Expression Processor 102 need only process the processing request 110 against the prospective rights expressions L1.Gg1.G1 and L4.G1, instead of processing L1.Gg1.G1, L2.G1, L3.G1, and L4. G1. However, the prerequisiteRights element in L1.Gg1.G1 causes a chain request of “can John Own Let's Rock CD.” In this case, the Expression Index Engine 106 retrieves the ∩(M(d₁=John), M(d₂=Own), M(d₃=Let's Rock CD)), as follows:

M(d₁=John)=L1.Gg1.G1, L1.Gg1.G2, L3.G1, L4.G1

M(d₂=Own)=L3.G1, L4.G1

M(d₃=Let's Rock CD)=L1.Gg1.G1, L1.Gg1.G2, L3.G1, L2.G1, L4.G1

∩(M(d₁=John), M(d₂=Own), M(d₃=Let's Rock CD))=L3.G1, L4.G1

Consequently, the Rights Expression Processor 102 need only process the processing request 110 against the prospective rights expressions L3.G1 and L4.G1, instead of processing L1.Gg1.G1, L1.Gg1.G2, L2.G1, L3.G1, and L4.G1.

Using such an indexing scheme, advantageously, only rights expressions that have the potential to match the processing request 110 need be processed against the processing request 110 by the Rights Expression Processor 102.

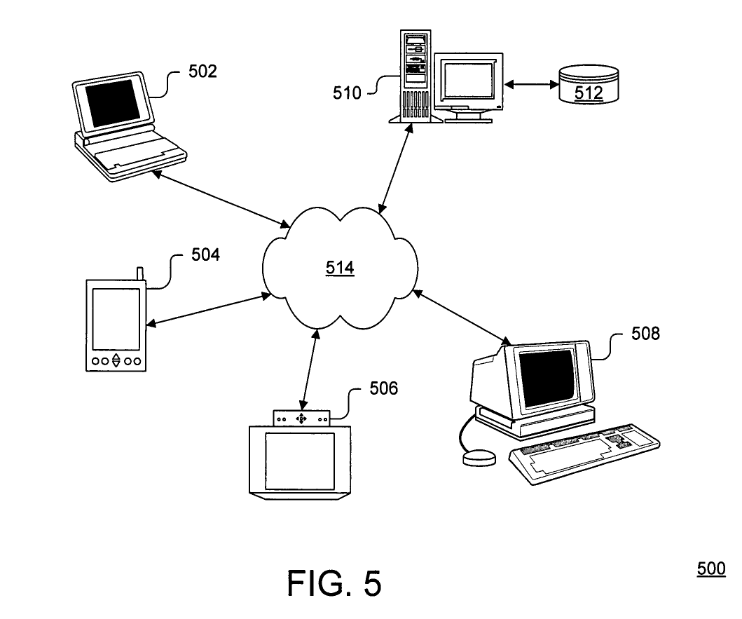

FIG. 5 illustrates a further exemplary system for processing of expressions and which can be used with the exemplary embodiments of FIGS. 1-4. In FIG. 5, the exemplary system 500 can include one or more devices or repositories 502-508, a content server 510, and content database 512, coupled together via a communications network 514. One or more of the devices 502-512 can be used to implement the exemplary embodiments of FIGS. 1-4, including managing of rights expression in a system of devices, repositories, and the like, for enforcing access to content or digital resources (e.g., software, music, movies, e-books, web services, etc.) in accordance with the rights expression.

The above-described devices and subsystems of the exemplary embodiments of FIGS. 1-5 can include, for example, any suitable servers, workstations, PCs, laptop computers, PDAs, Internet appliances, handheld devices, cellular telephones, wireless devices, other devices, and the like, capable of performing the processes of the exemplary embodiments of FIGS. 1-5. The devices and subsystems of the exemplary embodiments of FIGS. 1-5 can communicate with each other using any suitable protocol and can be implemented using one or more programmed computer systems or devices.

One or more interface mechanisms can be used with the exemplary embodiments of FIGS. 1-5, including, for example, Internet access, telecommunications in any suitable form (e.g., voice, modem, and the like), wireless communications media, and the like. For example, the communications network 714 can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the exemplary embodiments of FIGS. 1-5 are for exemplary purposes, as many variations of the specific hardware used to implement the exemplary embodiments are possible, as will be appreciated by those skilled in the relevant art(s). For example, the functionality of one or more of the devices and subsystems of the exemplary embodiments of FIGS. 1-5 can be implemented via one or more programmed computer systems or devices.

To implement such variations as well as other variations, a single computer system can be programmed to perform the special purpose functions of one or more of the devices and subsystems of the exemplary embodiments of FIGS. 1-5. On the other hand, two or more programmed computer systems or devices can be substituted for any one of the devices and subsystems of the exemplary embodiments of FIGS. 1-5. Accordingly, principles and advantages of distributed processing, such as redundancy, replication, and the like, also can be implemented, as desired, to increase the robustness and performance the devices and subsystems of the exemplary embodiments of FIGS. 1-5.

The devices and subsystems of the exemplary embodiments of FIGS. 1-5 can store information relating to various processes described herein. This information can be stored in one or more memories, such as a hard disk, optical disk, magneto-optical disk, RAM, and the like, of the devices and subsystems of the exemplary embodiments of FIGS. 1-5. One or more databases of the devices and subsystems of the exemplary embodiments of FIGS. 1-5 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 1-5 can include appropriate data structures for storing data collected and/or generated by the processes of the devices and subsystems of the exemplary embodiments of FIGS. 1-5 in one or more databases thereof.

All or a portion of the devices and subsystems of the exemplary embodiments of FIGS. 1-5 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments of FIGS. 1-5 can be implemented on the World Wide Web. In addition, the devices and subsystems of the exemplary embodiments of FIGS. 1-5 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments of FIGS. 1-5, for driving the devices and subsystems of the exemplary embodiments of FIGS. 1-5, for enabling the devices and subsystems of the exemplary embodiments of FIGS. 1-5 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the invention. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present invention can be distributed for better performance, reliability, cost, and the like.

As stated above, the devices and subsystems of the exemplary embodiments of FIGS. 1-5 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of exemplary embodiments and implementations, the present invention is not so limited but rather covers various modifications and equivalent arrangements, which fall within the purview of the appended claims.

What is claimed is:

1. A method for indexing expressions for use in a system for processing the expressions, the method comprising:
indexing an expression using a semantic value;
receiving a query;
generating a list of prospective expressions from indexed expressions based on the query; and
processing the prospective expressions.

2. The method of claim 1, wherein the indexing step further comprises indexing the expression using a syntactic value.

3. The method of claim 1, wherein the expression comprises a rights expression and the query is based on an authorization request.

4. The method of claim 1, wherein the indexing step includes indexing of an evaluation unit that can be independently indexed by values and types of one or more dimensional elements.

5. The method of claim 4, wherein the indexing step includes generating an indexed value of a dimensional element.

6. The method of claim 4, further comprising employing an expression index engine that retrieves based on a mathematical operation a collection of prospective evaluation units for an index query relating to a processing request.

7. The method of claim 4, wherein the evaluation unit comprises an expression element that represents a logical grouping of other expression elements.

8. The method of claim 4, wherein the expression includes a rights expression, and the evaluation unit comprises an authorization unit.

9. The method of claim 8, wherein the authorization unit comprises a rights expression element that represents a logical grouping of other rights expression elements and which allows an identity to exercise a right or action on a resource.

10. The method of claim 8, further comprising expressing the authorization unit using one of a grant element, and an agreement element.

11. The method of claim 4, wherein a dimensional element includes an expression element of the evaluation unit and which is used to compute an indexed value.

12. The method of claim 4, further comprising selecting the dimensional elements based on an anticipated processing request, such that the selected dimensional elements have corresponding input parameters with the processing request.

13. The method of claim 12, wherein when indexed values of all of the dimensional elements within the evaluation unit match the indexed values of the input parameters of the processing request, the evaluation unit has the potential to satisfy the processing request.

14. The method of claim 5, wherein the indexing step further includes generating a hash value computed from a type and value of the dimensional element.

15. The method of claim 1, wherein the expression includes a rights expression.

16. The method of claim 15, wherein the rights expression is expressed in one of MPEG REL, XrML, CRF CEL, XACML, SAML, OMA REL, and ODRL.

17. The method of claim 15, further comprising managing the rights expression in a system of repositories for enforcing access to content in accordance with the rights expression.

18. The method of claim 1, wherein the indexing step comprises adding the expression to an index collection.

19. The method of claim 18, wherein the indexing step further comprises ensuring that each evaluation unit corresponding to the expression is self-contained.

20. The method of claim 19, wherein the indexing step further comprises determining a hash value computed from type information and value of a dimensional element within each self-contained evaluation unit.

21. The method of claim 20, wherein the indexing step further comprises determining a seed syntactic value of the dimensional element.

22. The method of claim 21, wherein the indexing step further comprises:
employing the hash value as primary index key value; and
adding a reference to the evaluation unit to the indexed collection based on the primary index key value.

23. The method of claim 1, wherein the step of receiving the query regarding the expression comprises receiving a query for prospective evaluation units corresponding to the expression.

24. The method of claim 23, further comprising:
initiating a request based on the query; and
retrieving evaluation units to process against inputs from the request.

25. The method of claim 24, further comprising issuing a query to retrieve the prospective authorization units.

26. The method of claim 25, further comprising forming the query using the input parameters from the request that correspond to dimensional elements of the evaluation unit.

27. The method of claim 26, further comprising determining a hash value computed from type information and value for each dimension element corresponding the query.

28. The method of claim 27, further comprising determining a seed syntactic value of the dimensional elements.

29. The method of claim 28, further comprising determining an intersected collection of evaluation units based on hash values for each dimension element.

30. The method of claim 29, further comprising retrieving the collection of evaluation units with the hash value as the primary index key value.

31. The method of claim 30, further comprising determining the intersected collection by extracting evaluation units that are present in all of the collections of evaluation units retrieved.

32. The method of claim 6, wherein the mathematical operation includes an intersection of authorization units for dimensional elements denoted as ∩(M(d₁), M(d₂), . . . M(dₙ)).

33. The method of claim 6, wherein the mathematical operation includes a statistical function.

34. The method of claim 1, wherein the system for processing expressions comprises a system for enforcing rights expressions.

35. The method of claim 1, further comprising generating a seed syntactic value to represent the semantic value.

36. The method of claim 35, wherein the seed syntactic value depends on a context of an element of the expression.

37. The method of claim 1, further comprising employing a plug-in architecture.

38. The method of claim 37, wherein the plug-in architecture includes a semantic extension plug-in.

39. The method of claim 37, wherein the plug-in architecture includes a query handler plug-in.

40. The method of claim 1, further comprising indexing the expression using a semantic value of the expression.

41. The method of claim 1, further comprising receiving the query regarding the expression.

42. The method of claim 1, wherein the query is based on an evaluation request.

43. A computer system comprising one or more hardware and/or software devices configured to perform the steps recited in claim 1.

44. A computer readable medium including one or more computer-readable instructions embedded therein configured to cause one or more computer processors to perform the steps recited in claim 1.

45. A system for indexing expressions and for processing the expressions, the system comprising:
means for indexing an expression using a semantic value;
means for receiving a query;
means for generating a list of prospective expressions from indexed expressions based on the query; and
means for processing the prospective expressions.

46. The system of claim 45, wherein the indexing means further comprises means for indexing the expression using a syntactic value.

47. The system of claim 45, wherein the expression comprises a rights expression and the query is based on an authorization request.

48. The system of claim 45, wherein the indexing means includes means for indexing of an evaluation unit that can be independently indexed by values and types of one or more dimensional elements.

49. The system of claim 48, wherein the indexing means includes means for generating an indexed value of a dimensional element.

50. The system of claim 48, further comprising means for employing an expression index engine that retrieves based on a mathematical operation a collection of prospective evaluation units for an index query relating to a processing request.

51. The system of claim 48 wherein the evaluation unit comprises an expression element that represents a logical grouping of other expression elements.

52. The system of claim 48, wherein the expression includes a rights expression, and the evaluation unit comprises an authorization unit.

53. The system of claim 52, wherein the authorization unit comprises a rights expression element that represents a logical grouping of other rights expression elements and which allows an identity to exercise a right or action on a resource.

54. The system of claim 52, further comprising means for expressing the authorization unit using one of a grant element, and an agreement element.

55. The system of claim 48, wherein a dimensional element includes an expression element of the evaluation unit and which is used to compute an indexed value.

56. The system of claim 48, further comprising means for selecting the dimensional elements based on an anticipated processing request, such that the selected dimensional elements have corresponding input parameters with the processing request.

57. The system of claim 56, wherein when indexed values of all of the dimensional elements within the evaluation unit match the indexed values of the input parameters of the processing request, the evaluation unit has the potential to satisfy the processing request.

58. The system of claim 49, wherein the indexing means further includes means for generating a hash value computed from a type and value of the dimensional element.

59. The system of claim 45, wherein the expression includes a rights expression.

60. The system of claim 59, wherein the rights expression is expressed in one of MPEG REL, XrML, CRF CEL, XACML, SAML, OMA REL, and ODRL.

61. The system of claim 59, further comprising means for managing the rights expression in a system of repositories for enforcing access to content in accordance with the rights expression.

62. The system of claim 45, wherein the indexing means comprises means for adding the expression to an index collection.

63. The system of claim 62, wherein the indexing means further comprises means for ensuring that each evaluation unit corresponding to the expression is self-contained.

64. The system of claim 63, wherein the indexing means further comprises means for determining a hash value computed from type information and value of a dimensional element within each self-contained evaluation unit.

65. The system of claim 64, wherein the indexing means further comprises means for determining a seed syntactic value of the dimensional element.

66. The system of claim 65, wherein the indexing means further comprises:
means for employing the hash value as primary index key value; and
means for adding a reference to the evaluation unit to the indexed collection based on the primary index key value.

67. The system of claim 45, wherein the means for receiving the query regarding the expression comprises means for receiving a query for prospective evaluation units corresponding to the expression.

68. The system of claim 67, further comprising:
means for initiating a request based on the query; and
means for retrieving evaluation units to process against inputs from the request.

69. The system of claim 68, further comprising means for issuing a query to retrieve the prospective authorization units.

70. The system of claim 69, further comprising means for forming the query using the input parameters from the request that correspond to dimensional elements of the evaluation unit.

71. The system of claim 70, further comprising means for determining a hash value computed from type information and value for each dimension element corresponding the query.

72. The system of claim 71, further comprising means for determining a seed syntactic value of the dimensional elements.

73. The system of claim 72, further comprising means for determining an intersected collection of evaluation units based on hash values for each dimension element.

74. The system of claim 73, further comprising means for retrieving the collection of evaluation units with the hash value as the primary index key value.

75. The system of claim 74, further comprising means for determining the intersected collection by extracting evaluation units that are present in all of the collections of evaluation units retrieved.

76. The system of claim 50, wherein the mathematical operation includes an intersection of authorization units for dimensional elements denoted as ∩(M(d₁), M(d₂), . . . M(dₙ)).

77. The system of claim 50, wherein the mathematical operation includes a statistical function.

78. The system of claim 45, wherein the expression comprises a rights expression and the system comprises means for enforcing rights expressions.

79. The system of claim 45, further comprising means for generating a seed syntactic value to represent the semantic value.

80. The system of claim 79, wherein the seed syntactic value depends on a context of an element of the expression.

81. The system of claim 45, further comprising means for employing a plug-in architecture.

82. The system of claim 81, wherein the plug-in architecture includes a semantic extension plug-in.

83. The system of claim 81, wherein the plug-in architecture includes a query handler plug-in.

84. The system of claim 45, further comprising means for indexing the expression using a semantic value of the expression.

85. The system of claim 45, further comprising means for receiving the query regarding the expression.

86. The system of claim 45, wherein the query is based on an evaluation request.

87. The system of claim 45, wherein the means for indexing, means for receiving, means for generating, and means for processing comprise one or more hardware and/or software devices of a computer system.

88. A device for indexing expressions for use in a system for processing the expressions, the device comprising:
means for indexing an expression using a semantic value;
means for receiving a query; and
means for generating a list of prospective expressions from indexed expressions based on the query.

89. The device of claim 88, wherein the indexing means further comprises means for indexing the expression using a syntactic value.

90. The device of claim 88, wherein the expression comprises a rights expression and the query is based on an authorization request.

91. The device of claim 88, wherein the indexing means includes means for indexing of an evaluation unit that can be independently indexed by values and types of one or more dimensional elements.

92. The device of claim 91, wherein the indexing means includes means for generating an indexed value of a dimensional element.

93. The device of claim 91, further comprising means for employing an expression index engine that retrieves based on a mathematical operation a collection of prospective evaluation units for an index query relating to a processing request.

94. The device of claim 91 wherein the evaluation unit comprises an expression element that represents a logical grouping of other expression elements.

95. The device of claim 91, wherein the expression includes a rights expression, and the evaluation unit comprises an authorization unit.

96. The device of claim 95, wherein the authorization unit comprises a rights expression element that represents a logical grouping of other rights expression elements and which allows an identity to exercise a right or action on a resource.

97. The device of claim 95, further comprising means for expressing the authorization unit using one of a grant element, and an agreement element.

98. The device of claim 91, wherein a dimensional element includes an expression element of the evaluation unit and which is used to compute an indexed value.

99. The device of claim 91, further comprising means for selecting the dimensional elements based on an anticipated processing request, such that the selected dimensional elements have corresponding input parameters with the processing request.

100. The device of claim 99, wherein when indexed values of all of the dimensional elements within the evaluation unit match the indexed values of the input parameters of the processing request, the evaluation unit has the potential to satisfy the processing request.

101. The device of claim 92, wherein the indexing means further includes means for generating a hash value computed from a type and value of the dimensional element.

102. The device of claim 88, wherein the expression includes a rights expression.

103. The device of claim 102, wherein the rights expression is expressed in one of MPEG REL, XrML, CRF CEL, XACML, SAML, OMA REL, and ODRL.

104. The device of claim 102, further comprising means for managing the rights expression in a system of repositories for enforcing access to content in accordance with the rights expression.

105. The device of claim 88, wherein the indexing means comprises means for adding the expression to an index collection.

106. The device of claim 105, wherein the indexing means further comprises means for ensuring that each evaluation unit corresponding to the expression is self-contained.

107. The device of claim 106, wherein the indexing means further comprises means for determining a hash value computed from type information and value of a dimensional element within each self-contained evaluation unit.

108. The device of claim 107, wherein the indexing means further comprises means for determining a seed syntactic value of the dimensional element.

109. The device of claim 108, wherein the indexing means further comprises:
means for employing the hash value as primary index key value; and
means for adding a reference to the evaluation unit to the indexed collection based on the primary index key value.

110. The device of claim 88, wherein the means for receiving the query regarding the expression comprises means for receiving a query for prospective evaluation units corresponding to the expression.

111. The device of claim 110, further comprising:
means for initiating a request based on the query; and
means for retrieving evaluation units to process against inputs from the request.

112. The device of claim 111, further comprising means for issuing a query to retrieve the prospective authorization units.

113. The device of claim 112, further comprising means for forming the query using the input parameters from the request that correspond to dimensional elements of the evaluation unit.

114. The device of claim 113, further comprising means for determining a hash value computed from type information and value for each dimension element corresponding the query.

115. The device of claim 114, further comprising means for determining a seed syntactic value of the dimensional elements.

116. The device of claim 115, further comprising means for determining an intersected collection of evaluation units based on hash values for each dimension element.

117. The device of claim 116, further comprising means for retrieving the collection of evaluation units with the hash value as the primary index key value.

118. The device of claim 117, further comprising means for determining the intersected collection by extracting evaluation units that are present in all of the collections of evaluation units retrieved.

119. The device of claim 93, wherein the mathematical operation includes an intersection of authorization units for dimensional elements denoted as ∩(M(d₁), M(d₂), . . . M(dₙ)).

120. The device of claim 93, wherein the mathematical operation includes a statistical function.

121. The device of claim 88, wherein the expression comprises a rights expression and the device further includes means for enforcing rights expressions.

122. The device of claim 88, further comprising means for generating a seed syntactic value to represent the semantic value.

123. The device of claim 122, wherein the seed syntactic value depends on a context of an element of the expression.

124. The device of claim 88, further comprising means for employing a plug-in architecture.

125. The device of claim 124, wherein the plug-in architecture includes a semantic extension plug-in.

126. The device of claim 124, wherein the plug-in architecture includes a query handler plug-in.

127. The device of claim 88, further comprising means for indexing the expression using a semantic value of the expression.

128. The device of claim 88, further comprising means for receiving the query regarding the expression.

129. The device of claim 88, wherein the query is based on an evaluation request.

130. The device of claim 88, wherein the means for indexing, means for receiving, and means for generating comprise one or more hardware and/or software devices of a computer system.

131. A computer readable medium including one or more computer-readable instructions embedded therein for indexing expressions for use in a system for processing the expressions and configured to cause one or more computer processors to perform the steps of:
indexing an expression using a semantic value;
receiving a query;
generating a list of prospective expressions from indexed expressions based on the query; and
processing the prospective expressions.

132. The computer readable medium of claim 131, wherein the indexing step further comprises indexing the expression using a syntactic value.

133. The computer readable medium of claim 131, wherein the expression comprises a rights expression and the query is based on an authorization request.

134. The computer readable medium of claim 131, wherein the indexing step includes indexing of an evaluation unit that can be independently indexed by values and types of one or more dimensional elements.

135. The computer readable medium of claim 134, wherein the indexing step includes generating an indexed value of a dimensional element.

136. The computer readable medium of claim 134, further comprising computer-readable instructions configured to cause the computer processors to perform the step of employing an expression index engine that retrieves based on a mathematical operation a collection of prospective evaluation units for an index query relating to a processing request.

137. The computer readable medium of claim 134, wherein the evaluation unit comprises an expression element that represents a logical grouping of other expression elements.

138. The computer readable medium of claim 134, wherein the expression includes a rights expression, and the evaluation unit comprises an authorization unit.

139. The computer readable medium of claim 138, wherein the authorization unit comprises a rights expression element that represents a logical grouping of other rights expression elements and which allows an identity to exercise a right or action on a resource.

140. The computer readable medium of claim 138, further comprising computer-readable instructions configured to cause the computer processors to perform the step of expressing the authorization unit using one of a grant element, and an agreement element.

141. The computer readable medium of claim 134, wherein a dimensional element includes an expression element of the evaluation unit and which is used to compute an indexed value.

142. The computer readable medium of claim 134, further comprising computer-readable instructions configured to cause the computer processors to perform the step of selecting the dimensional elements based on an anticipated processing request, such that the selected dimensional elements have corresponding input parameters with the processing request.

143. The computer readable medium of claim 142, wherein when indexed values of all of the dimensional elements within the evaluation unit match the indexed values of the input parameters of the processing request, the evaluation unit has the potential to satisfy the processing request.

144. The computer readable medium of claim 135, wherein the indexing step further includes generating a hash value computed from a type and value of the dimensional element.

145. The computer readable medium of claim 131, wherein the expression includes a rights expression.

146. The computer readable medium of claim 145, wherein the rights expression is expressed in one of MPEG REL, XrML, CRF CEL, XACML, SAML, OMA REL, and ODRL.

147. The computer readable medium of claim 145, further comprising computer-readable instructions configured to cause the computer processors to perform the step of managing the rights expression in a system of repositories for enforcing access to content in accordance with the rights expression.

148. The computer readable medium of claim 131, wherein the indexing step comprises adding the expression to an index collection.

149. The computer readable medium of claim 148, wherein the indexing step further comprises ensuring that each evaluation unit corresponding to the expression is self-contained.

150. The computer readable medium of claim 149, wherein the indexing step further comprises determining a hash value computed from type information and value of a dimensional element within each self-contained evaluation unit.

151. The computer readable medium of claim 150, wherein the indexing step further comprises determining a seed syntactic value of the dimensional element.

152. The computer readable medium of claim 151, wherein the indexing step further comprises:
employing the hash value as primary index key value; and
adding a reference to the evaluation unit to the indexed collection based on the primary index key value.

153. The computer readable medium of claim 131, wherein the step of receiving the query regarding the expression comprises receiving a query for prospective evaluation units corresponding to the expression.

154. The computer readable medium of claim 153, further comprising computer-readable instructions configured to cause the computer processors to perform the steps of:
initiating a request based on the query; and
retrieving evaluation units to process against inputs from the request.

155. The computer readable medium of claim 154, further comprising issuing a query to retrieve the prospective authorization units.

156. The computer readable medium of claim 155, further comprising computer-readable instructions configured to cause the computer processors to perform the step of forming the query using the input parameters from the request that correspond to dimensional elements of the evaluation unit.

157. The computer readable medium of claim 156, further comprising computer-readable instructions configured to cause the computer processors to perform the step of determining a hash value computed from type information and value for each dimension element corresponding the query.

158. The computer readable medium of claim 157, further comprising computer-readable instructions configured to cause the computer processors to perform the step of determining a seed syntactic value of the dimensional elements.

159. The computer readable medium of claim 158, further comprising computer-readable instructions configured to cause the computer processors to perform the step of determining an intersected collection of evaluation units based on hash values for each dimension element.

160. The computer readable medium of claim 159, further comprising computer-readable instructions configured to cause the computer processors to perform the step of retrieving the collection of evaluation units with the hash value as the primary index key value.

161. The computer readable medium of claim 160, further comprising computer-readable instructions configured to cause the computer processors to perform the step of determining the intersected collection by extracting evaluation units that are present in all of the collections of evaluation units retrieved.

162. The computer readable medium of claim 136, wherein the mathematical operation includes an intersection of authorization units for dimensional elements denoted as ∩(M(d₁), M(d₂), . . . M(dₙ)).

163. The computer readable medium of claim 136, wherein the mathematical operation includes a statistical function.

164. The computer readable medium of claim 131, wherein the system for processing expressions comprises a system for enforcing rights expressions.

165. The computer readable medium of claim 131, further comprising computer-readable instructions configured to cause the computer processors to perform the step of generating a seed syntactic value to represent the semantic value.

166. The computer readable medium of claim 165, wherein the seed syntactic value depends on a context of an element of the expression.

167. The computer readable medium of claim 131, further comprising computer-readable instructions configured to cause the computer processors to perform the step of employing a plug-in architecture.

168. The computer readable medium of claim 167, wherein the plug-in architecture includes a semantic extension plug-in.

169. The computer readable medium of claim 167, wherein the plug-in architecture includes a query handler plug-in.

170. The computer readable medium of claim 131, further comprising computer-readable instructions configured to cause the computer processors to perform the step of indexing the expression using a semantic value of the expression.

171. The computer readable medium of claim 131, further comprising computer-readable instructions configured to cause the computer processors to perform the step of receiving the query regarding the expression.

172. The computer readable medium of claim 131, wherein the query is based on an evaluation request.
